(19) United States
(12) Patent Application Publication
(10) Pub. No.: US 2017/0245965 A1
(43) Pub. Date: Aug. 31, 2017

(54) METHOD FOR DENTAL IMPLANT INSERTION

(71) Applicant: Wolfgang Schmuedderich, MEERBUSCH (DE)

(72) Inventor: Wolfgang Schmuedderich, MEERBUSCH (DE)

(21) Appl. No.: 15/587,961

(22) Filed: May 5, 2017

Related U.S. Application Data
(62) Division of application No. 14/477,896, filed on Sep. 5, 2014.

(30) Foreign Application Priority Data
Sep. 5, 2013 (DE) 10 2013 014 690.9

(51) Int. Cl. A61C 8/00

(52) U.S. Cl. CPC A61C 8/005; A61C 8/0012; A61C 2008/0046; A61C 8/00

(57) ABSTRACT

An implant for anchoring a tooth replacement includes an endosseous part comprising a ceramic sleeve at a first end of the endosseous part. The endosseous part is configured to be embedded to a full height of the endosseous part in a bone.

CROSS REFERENCE TO PRIOR APPLICATIONS

This application is a division of copending U.S. patent application Ser. No. 14/477,896, entitled IMPLANT AND DENTAL PROSTHESES SYSTEM, filed Sep. 5, 2014, which claims priority to German Patent Application No. 10 2013 014 690.9, filed Sep. 5, 2013, pursuant to 35 U.S.C. §119(a)-(d), all of which are hereby incorporated by reference in their entireties for all purposes.

### FIELD

The present invention relates to an implant, in particular to an implant for anchoring a tooth replacement, which implant has an endosseous part, and to a system for tooth replacement.

### BACKGROUND

Dental implants in common use today are generally screws that function according to the principle of a dowel.

Implantation in the jawbone is performed in a minor procedure under sterile conditions. The implant is generally screwed into the bone (outer thread) using special instruments and with a torque of 30-40 Ncm.

After the implant has become incorporated in the bone (osseointegration), it is fitted with a superstructure which is screwed into the inner thread. This is followed by the phase of prosthetic use.

Most implant types are provided in two parts. One-part implants also exist, however, to in particular anchor total prostheses in which the prosthetic superstructure is rigidly connected to the screw part to be introduced into the bone. Incorporation takes place under the closed mucosal cover (subgingival/two-part implants) or also in contact with the oral cavity (transgingival/one-part implants).

Titanium implants are considered the gold standard regarding implant materials in current use. Titanium of purity degree 4 (pure titanium) is used. Titanium has an osteoconductive action in contact with bone. Bone-forming cells (osteoblasts) settle on the implant surface and lead to osseous impregnation of the implant, resulting in direct contact between bone cells and the implant surface (osseointegration). The implant parts located in the bone (i.e., the screw thread) are roughened to support this process. This results in an increased surface area. Osteoblasts appear to find ideal conditions to settle in the microscopic depressions of the rough surface, which promotes the subsequent formation of bone.

WO 2008/009474 A1 describes an implant for anchoring a tooth replacement in which an endosseous portion and a gingival portion are provided. The endosseous portion is made of titanium or of a titanium alloy. The gingival portion has a coating of zirconium nitride and/or zirconium oxide.

### SUMMARY

An aspect of the present invention is to provide an improved tooth implant to optimize the incorporation process, for example, in the case of bone deficits in the crestal region of the jaw, and to prevent bone resorption caused by inflammation.

In an embodiment, the present invention provides an implant for anchoring a tooth replacement which includes an endosseous part comprising a ceramic sleeve at a first end of the endosseous part. The endosseous part is configured to be embedded to a full height of the endosseous part in a bone.

### BRIEF DESCRIPTION OF THE DRAWINGS

The present invention is described in greater detail below on the basis of embodiments and of the drawings in which:

FIG. 1 shows a partial cross-sectional view of an implant according to the present invention in a jawbone;

FIG. 2 shows an exploded view of the implant according to the present invention;

### DETAILED DESCRIPTION

The core aspect of the present invention is to arrange the materials so that optimal conditions for osseointegration and incorporation are present even in cases of bone deficit or bone resorption. An implant, in particular for anchoring a tooth replacement, is made available which has an endosseous part that can be embedded to its full height in the bone, wherein the endosseous part has a ceramic sleeve at one end. The endosseous part is embedded together with the ceramic sleeve in the bone. The implant shoulder, i.e., the end area of the endosseous part, bears on the bone surface or below the latter. Only in the case of inflammatory bone resorption can the ceramic ring come into contact with soft tissue and offer optimal conditions for healing the inflammation since the ceramic surface cannot be colonized by microorganisms.

The underlying concept of the implant according to the present invention combines the previously-described positive biological properties of the two materials, each one located at the position significant for its biological effects.

Osseointegration can proceed here in the usual way by introducing a roughened titanium surface into the bone. The design principle of the two-part implant can at the same time be maintained so that it is still possible for incorporation to take place under a cover especially in cases where augmentation is required, and for the superstructure parts to be exchanged if required.

In an embodiment of the present invention, the implant can, for example, be an implant composed of two or more parts so that the endosseous part of the implant can become incorporated in a closed position under the mucosal cover. So-called implantation protocols provide instructions on the surgical procedure, in particular, on how to introduce the endosseous part into the jawbone. The present invention provides an implantation protocol for the implant pursuant to which the endosseous part can be embedded to its full height in the jawbone in order to permit incorporation within a closed space. The implantation protocol for the implant according to the present invention thus provides a surgical procedure that takes place on two occasions. The implant according to the present invention is accordingly a multi-part implant having an endosseous part (the implant body anchored in the bone) and a head part (the abutment that receives the superstructure). It is possible to provide a so-called neck part between the endosseous part and the abutment which is arranged in the oral mucosa. The two or three parts of the implant according to the present invention can, for example, be screwed together. The so-called superstructures (crowns, bridges or prosthesis anchors) can be screwed, cemented, adhesively bonded, or connected by other means.

The advantage of the ceramic materials is that they promote the deposition of bone by virtue of their inert properties at the sensitive interface between the implant shoulder and the intraoral soft tissue. This applies, for example, in cases where implants are to be inserted into the already atrophied alveolar process with transverse bone deficit. Even in cases where bone formation in a circle around the implant shoulder fails to materialize and/or takes place only incompletely, the ceramic surface provides optimal conditions for attachment of the soft tissues around the implant. There is then no longer any need for a preparatory smoothing of the bone which is always associated with a certain loss of bone height.

In the event of bone receding around the implant, it is moreover to be expected that the then resulting exposure of a smoothly polished ceramic surface, which can counteract the deposition of plaque, will make it possible to avoid or lessen peri-implantitis.

In an embodiment of the present invention, the ceramic can, for example, be an aluminum oxide ceramic, for example, zirconium oxide ceramic. Zirconium oxide ceramics have very good properties as regards flexural strength and stability under pressure.

Zirconium oxide ceramics for dental implants are produced by firing and sintering and, if appropriate, pressing. They are generally stabilized by addition of yttrium. In contrast to titanium, ceramics are inert upon contact with bone, i.e., they allow bone to form at their interface. The ceramic surfaces in contact with the bone are smooth. The ceramic surfaces can. for example, be polished. This provides the optimal condition for osseointegration in ceramic implants.

The tooth-supporting portion of the jaw, namely, the alveolar process, receives the roots of the teeth. It is composed of spongy bone and is delimited toward the sides by a harder and solid cortical osseous lamella. In the lower jaw, the alveolar process sits on a solid bone in which the sensitive inferior dental nerve runs in the area of the posterior teeth. In the upper jaw, the maxillary and nasal sinuses directly adjoin the alveolar process.

The tooth sockets, or alveoli, are composed internally of bundle bone which derives nourishment from the periodontium of the respective tooth. This bundle bone is no longer nourished and undergoes atrophy if a tooth is lost. This results in a volume defect of the alveolar process.

Following the loss of a tooth, the absence of functional stimuli on the jawbone also leads to resorption of the tooth-supporting portion of the jaw. This may be localized or, if several or even all of the teeth are missing, it may be of a generalized nature. A distinction is made between vertical and transverse bone resorption.

Resorption in the transverse direction begins directly after loss of the tooth, principally in the area of the vestibular osseous lamella. Up to 40% of the width of the bone is already resorbed after about three months. The vertical bone resorption takes place more slowly. It is associated with slightly lesser resorption of the bone height of 2 to 3 mm and principally affects the crestal portions of the alveolar process, whereas the bone extending to the base of the jaw retains its original size. In the area of the posterior teeth of the upper jaw, the maxillary sinus also extends into the jaw portions in which the roots of the posterior teeth were previously located.

When a tooth has been missing for quite a long time, the jawbone thus generally has a wedge-shaped cross section tapering toward the oral cavity.

The implant of present invention provides that inflammation of the (tissue) areas around the implant (peri-implantitis) can be alleviated. Peri-implantitis can affect the area of the mucous membrane (peri-implant mucositis) or also the bone surrounding the implant (peri-implant osteitis). In the latter case, with conventional implants, the fermentative resorption of bone leads to exposure of roughened implant surfaces. A biofilm of protein from saliva and of the tissue fluids builds up on the exposed surfaces. This biofilm generates microorganisms of a nutrient base, which in turn favors the progression of the inflammation. A vicious circle ensues which ultimately leads to the loss of the implant. The implant according to the present invention minimizes or prevents additional surgical measures such as building-up of bone or bone expansion since the bone formation is promoted by the material properties of the ceramic.

With advancing age, sometimes exacerbated by diseases such as osteoporosis, diabetes mellitus, tumor diseases requiring chemotherapy, and diseases requiring immuno-suppressant therapy, the implants described in the prior art can also lead to accelerated bone resorption in the bone around the implant, with resulting exposure of the rough implant surface. The contents of cigarette smoke may promote these processes.

In an embodiment of the present invention, the tooth implant can, for example, be dimensioned so that, when inserted, it is surrounded on all sides by 1.5 mm of bone. The shape and size of the tooth crown to be replaced can, for example, influence the diameter of the implant at its shoulder leading into the oral cavity.

To replace a large posterior tooth, an implant can, for example, be chosen that is as wide as possible (approximately 5 mm). To replace a narrow incisor, use can, for example, be made of an implant shoulder that is as narrow as possible.

Various methods are available if the crestal jawbone is too narrow which include:
smoothing the tapered alveolar process, thereby creating a broader bed at the expense of bone height;
splitting the crestal bone and then spreading it;
depositing particulate bone or similar bone substitute material in the area of the bone deficits and then covering this with a collagen membrane; and
building the bone up (transplantation of an autologous bone block).

Common features of the aforementioned methods are an increased surgical outlay (additional intervention/extensive shaping of the mucosa) and an increased surgical risk (failure of the augmented areas to osseointegrate, with consequent exposure of implant surfaces and the risk of peri-implantitis).

In an embodiment of the present invention, the ceramic sleeve can, for example, be configured so that the sleeve is annular. The sleeve can be secured on the implant shoulder over the metal body.

The metal body and the sleeve can be adapted to each other so that the external dimension of the sleeve substantially corresponds to the external dimension of the metal body. For this purpose, the metal body can have a milled portion in the area of the implant shoulder, which milled portion is designed to support the sleeve designed as a ring. The implant can substantially retain its cylindrical or root-shaped configuration, as seen in a side view. A widening of the implant shoulder by the sleeve is not provided.

An annular shape according to the present invention is to be understood as a shape that approximates a ring but also permits symmetrical or asymmetrical polygonal shapes in cross section. In an embodiment of the present invention, the outer cross section of the sleeve can, for example, be annular. The inner circumference of the sleeve can likewise be annular. Deviations from the annular shape are also possible, including symmetrical or asymmetrical polygonal shapes. It is also possible that the sleeve has an outer thread which continues an outer thread of the metal body. The outer thread of the sleeve and of the metal body can correspond to each other. The outer thread of the sleeve and the outer thread of the metal body can, for example, have the same pitch.

The sleeve and/or the metal body can, for example, be milled using CAD/CAM technology.

In an embodiment of the present invention, the sleeve can, for example, be designed as a ring that can be secured on the shoulder of the metal body. The ring can be affixed in the area of the implant shoulder by means of an adhesive (analogous to the adhesion bonding of a ceramic inlay). An adhesive with good biocompatibility can be used (e.g., Panavia®). Adhesives for implant superstructures are known from the company called Camlog®.

In an embodiment of the present invention, the ring is applied in the area of the implant shoulder after prior heating using the specific thermal coefficient of expansion for the ceramic so as to obtain a press fit which lies above a torque of approximately 60 Ncm.

In an embodiment of the present invention, the metal body of the endosseous part has a coating which is designed about its circumference at one end.

The present invention is explained in more detail below on the basis of an illustrative embodiment as shown in the drawings.

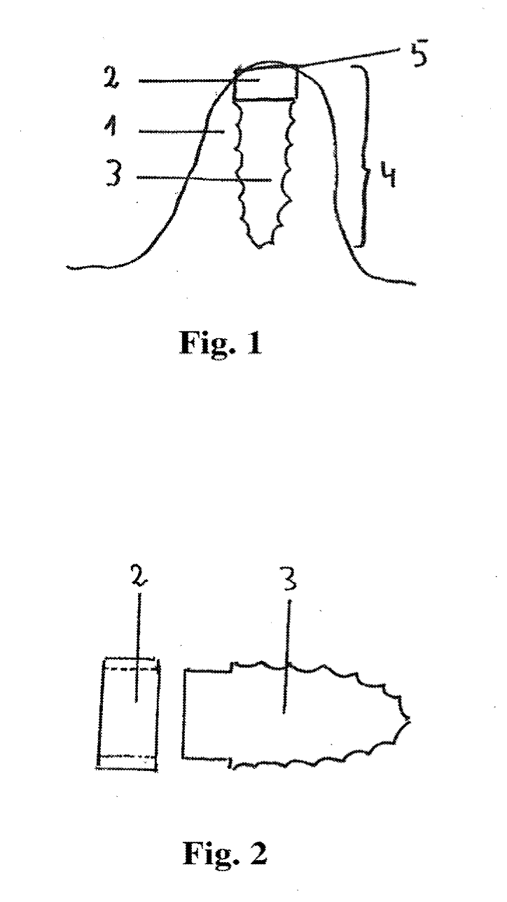

FIG. 1 shows a cross-sectional view of an endosseous part 4 of an implant according to the present invention inserted into a jawbone 1. The endosseous part 4 is embedded completely in the jawbone 1. The endosseous part 4 has a metal body 3 and a sleeve 2 which has a ceramic or is made of a ceramic. The endosseous part 4 is embedded to its full height in the jawbone 1. The implant shoulder 5 is surrounded by the jawbone 1.

FIG. 2 shows an exploded view in which the sleeve 2, secured on the metal body 3 during actual use, is shown separate from the metal body 3.

The metal body 3 can be secured to the jawbone via the outer thread of the metal body 3. The endosseous part 4 is screwed into the jawbone 1. The sleeve 2 is connected to the metal body 3 by a cohesive connection and/or by means of a press fit.

An inner thread can be provided in the metal body 3, an abutment 7 and/or a superstructure adapted to the metal body 3 is screwed into and/or adhesively bonded to the inner thread.

The present invention is not limited to embodiments described herein; reference should be had to the appended claims.

What is claimed is:

1. A method for inserting a dental implant into bone, comprising:
positioning, adjacent to a jawbone, a dental implant for anchoring a tooth replacement, the dental implant having an endosseous part comprising:
a ceramic sleeve in an area of a shoulder of the implant, and
a metal body comprising a front end, the metal body being configured to be screwed into the bone,
embedding the dental implant in the jawbone to a full height of the endosseus part.

2. The method of claim 1, wherein the embedding comprises rotating the dental implant.

3. The method of claim 2, wherein the metal body has an external thread, and the embedding comprises screwing the dental implant into the bone.

4. The method of claim 1, wherein, upon completion of the embedding, the implant is surrounded on all sides by at least 1.5 mm of bone.

5. The method of claim 1, wherein a continuous thread is defined on an exterior surface of the metal body and an exterior surface of the ceramic sleeve, and the embedding comprises screwing the dental implant into the bone.
